(19) United States
(12) Patent Application Publication
(10) Pub. No.: US 2003/0190929 A1
(43) Pub. Date: Oct. 9, 2003

(54) Wireless telecommunicating and transforming assembly

(76) Inventor: Roger Wu, Hsin Chuang City (TW)

Correspondence Address: ROGER WU, P.O. Box 4-67, Hsin Chuang, Taipei, 242, TW

(21) Appl. No.: 10/117,794

(22) Filed: Apr. 5, 2002

(51) Int. Cl. H04M 1/00

(52) U.S. Cl. 455/557; 455/558

(57) ABSTRACT

A wireless telecommunicating and transforming assembly includes a telecommunicating and transforming device having a coupler and one or more antennas for communicating purposes, and a card having another coupler for selectively coupling to the coupler of the telecommunicating and transforming device and having a wireless local area network for allowing the wireless telecommunicating and transforming assembly to include two functions simultaneously, and for allowing the assembly to be used outdoors. The device may include a GPRS, or a CDMA, or a GSM, or a PHS.

### BACKGROUND OF THE INVENTION

1. Field of the Invention

The present invention relates to a telecommunicating device, and more particularly to a wireless telecommunicating and transforming assembly.

2. Description of the Prior Art

Typical telecommunicating devices comprise the cards of the personal computer memory card international association (PCMCIA), or the compact cards, or the other cards that may include a wireless local area network (WLAN) provided therein, For telecommunicating purposes, the PCMCIA cards or the compact cards are required to be plugged to the personal computers or the like, such that the PCMCIA cards or the compact cards may be used indoors only, and may not be used outdoors.

The present invention has arisen to mitigate and/or obviate the afore-described disadvantages of the conventional telecommunicating devices.

### SUMMARY OF THE INVENTION

The primary objective of the present invention is to provide a wireless telecommunicating and transforming assembly including an antenna device for allowing the wireless telecommunicating and transforming assembly to be used outdoors.

In accordance with one aspect of the invention, there is provided a wireless telecommunicating and transforming assembly comprising a telecommunicating and transforming device including a first coupler provided therein, and including at least one antenna attached thereto for wireless communicating purposes, and a card including a second coupler for selectively coupling with the first coupler, and for selectively coupling to the telecommunicating and transforming device, the card including a wireless local area network provided therein, for allowing the wireless telecommunicating and transforming assembly to include two functions provided or coupled therein simultaneously, and for allowing the wireless telecommunicating and transforming assembly to be used outdoors.

The telecommunicating and transforming device may include a GPRS, or a CDMA, or a GSM, or a PHS provided therein.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is an exploded view showing the members of a wireless telecommunicating and transforming assembly in accordance with the present invention; and

FIGS. 2 and 3 are perspective views illustrating the operation of the wireless telecommunicating and transforming assembly.

### DETAILED DESCRIPTION OF THE PREFERRED EMBODIMENT

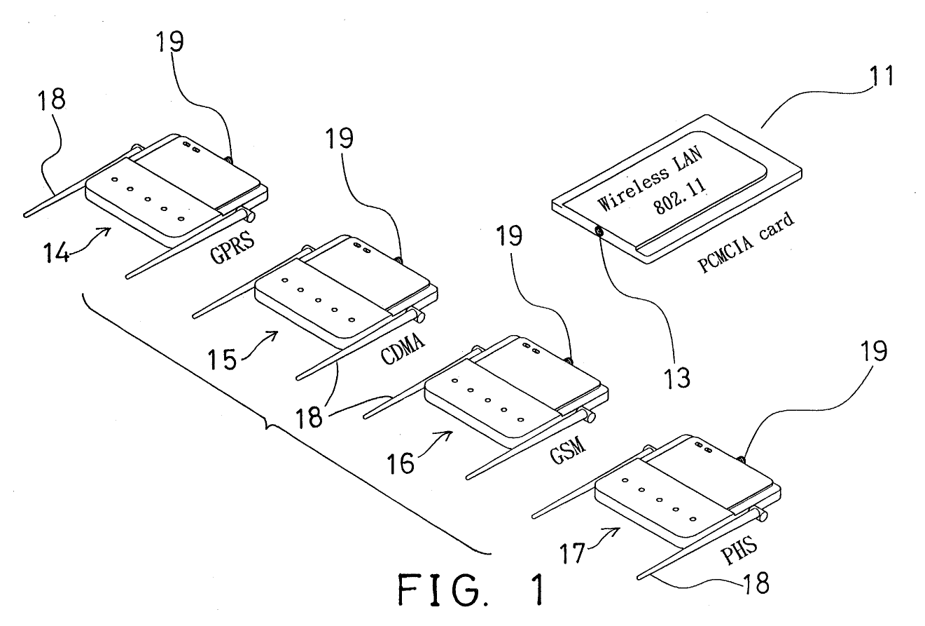

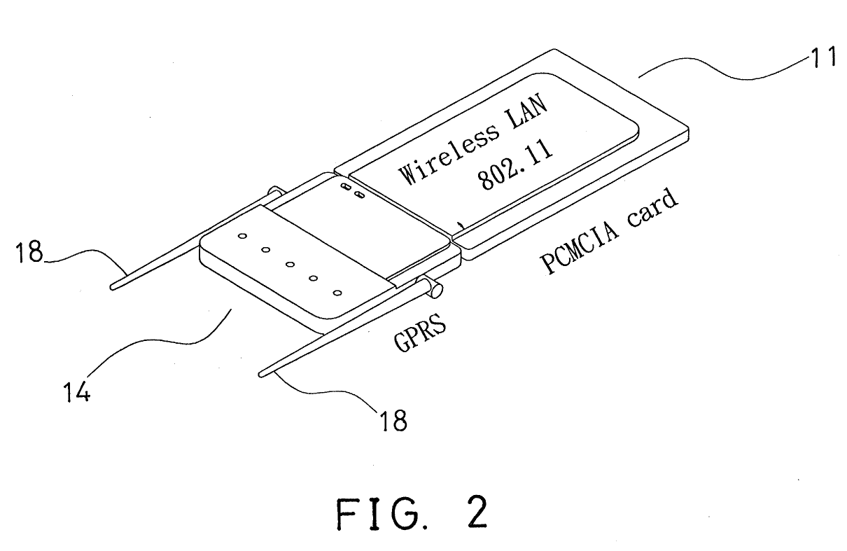

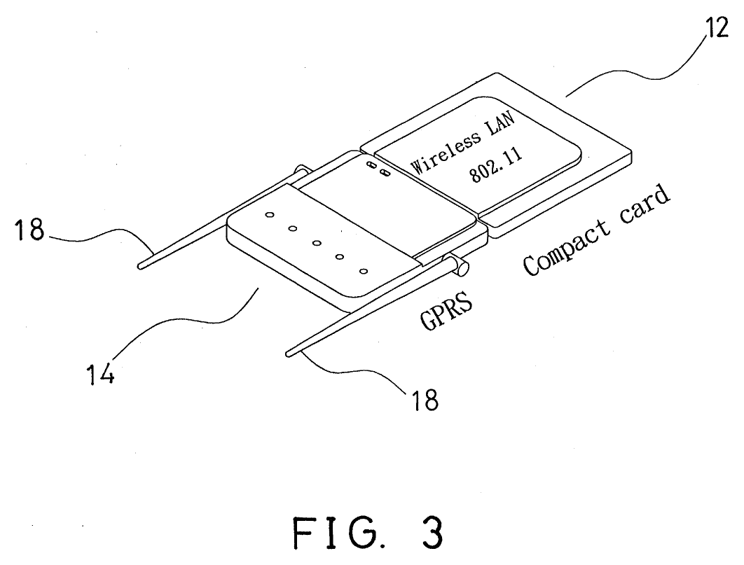

Referring to the drawings, and initially to FIGS. 1 and 2, a wireless telecommunicating and transforming assembly in accordance with the present invention comprises one or more telecommunicating and transforming devices 14, 15, 16, 17 each including a plug or a coupler 19 provided thereon for plugging or coupling to a socket or opening or another coupler 13 of a PCMCIA card 11 (FIGS. 1, 2) and/or a compact flash card or a compact card 12 (FIG. 3). The PCMCIA card 11 and/or the compact card 12 each includes a WLAN, such as a 802.11 WLAN provided therein.

The telecommunicating and transforming devices 14-17 may include such as a general packet radio service (PPRS), a code division multiple access (CDMA), a global system for mobile communication (GSM), or a personal handy phone system (PHS) provided therein respectively; and may each include one or more antennas 18 attached and coupled thereto for wireless telecommunicating and transforming purposes.

In operation, the wireless telecommunicating and transforming assembly in accordance with the present invention may include two functions provided therein or coupled therein simultaneously, such as the GPRS (14)+WLAN 802.11, or CDMA (15)+WLAN 802.11, or GSM (16)+WLAN 802.11, or PHS (17)+WLAN 802.11. In addition, the GPRS (14) and the CDMA (15) and the GSM (16) and the PHS (17) may be changed with each other, for allowing the wireless telecommunicating and transforming assembly to be easily coupled to the other communicating systems or facilities.

Accordingly, the wireless telecommunicating and transforming assembly in accordance with the present invention includes an antenna device for allowing the wireless telecommunicating and transforming assembly to be used outdoors.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A wireless telecommunicating and transforming assembly comprising:
a telecommunicating and transforming device including a first coupler provided therein, and including at least one antenna attached thereto for wireless communicating purposes, and
a card including a second coupler for selectively coupling with said first coupler, and for selectively coupling to said telecommunicating and transforming device, said card including a wireless local area network provided therein.

2. The assembly according to claim 1, wherein said telecommunicating and transforming device includes a GPRS provided therein.

3. The assembly according to claim 1, wherein said telecommunicating and transforming device includes a CDMA provided therein.

4. The assembly according to claim 1, wherein said telecommunicating and transforming device includes a GSM provided therein.

5. The assembly according to claim 1, wherein said telecommunicating and transforming device includes a PHS provided therein.
